(19) United States
(12) Patent Application Publication
(10) Pub. No.: US 2019/0205769 A1
(43) Pub. Date: Jul. 4, 2019

(54) Data Processing Method, Apparatus, Device and Computer Readable Storage Media

(71) Applicant: Alibaba Group Holding Limited, Grand Cayman (KY)

(72) Inventors: Pengjun XIE, Hangzhou (CN); Jun Lang, Hangzhou (CN); Luo SI, Seattle, WA (US)

(73) Assignee: Alibaba Group Holding Limited

(21) Appl. No.: 16/234,370

(22) Filed: Dec. 27, 2018

(30) Foreign Application Priority Data
Dec. 28, 2017 (CN) 201711464885.0

(51) Int. Cl. G06N 3/12; G06N 5/04; G06Q 30/06; G06F 17/27

(52) U.S. Cl. CPC G06N 3/126; G06F 17/278; G06Q 30/0613; G06N 5/048

(57) ABSTRACT

Data processing method, apparatus, device and computer readable storage media are provided. A first product object is selected. One or more candidate product objects that are similar to the first product object are determined. A candidate question set is constructed for the first product object based on existing user questions of the one or more candidate product objects. Based on the candidate question set of the first product object, a recommended question set of the first product object is constructed. The data processing method, apparatus, device and computer readable storage media of the embodiments of the present disclosure are capable of pushing questions. Furthermore, since the candidate product objects are similar to the first product object, the candidate question set and the recommended question set of the first product object are constructed based on the existing user questions of the candidate product objects, and questions that are recommended can reflect points of concern of other users about the product object.

### CROSS REFERENCE TO RELATED PATENT APPLICATIONS

This application claims priority to Chinese Patent Application No. 201711464885.0, filed on 28 Dec. 2017, entitled “Data Processing Method, Apparatus, Device and Computer Readable Storage Media,” which is hereby incorporated by reference in its entirety.

### TECHNICAL FIELD

The present disclosure relates to the technical field of computer technologies, and particularly to data processing methods, apparatuses, devices and computer readable storage media.

### BACKGROUND

With the increasing popularity of e-commerce applications, online shopping has been integrated into the basic necessities of users' lives.

Before a user makes a purchase, the user usually makes an inquiry about a product to be purchased by asking questions about the product. For example, if a user wants to buy a skirt, the user may ask “Will the skirt lose color?”, “Can the skirt be machine-washed?”, “Height is 155, weight is 110, and what size is suitable!”

In order to improve the efficiency of users' questioning about goods, current technologies provide two approaches for recommending questions.

First method: According to a keyword inputted by a user for a product, a question similar to the keyword is retrieved from existing questions corresponding to the product, and the retrieved question is recommended to the user.

Second method: Some general questions, such as “How is the quality?”, “Is it cost-effective?”, etc., are built up in advance, and these general questions are recommended to a user.

However, through the first method, only questions similar to a keyword inputted by a user can be recommended to the user. If no question similar to the keyword exists among existing questions corresponding to a product, no question can be recommended to the user. Through the second method, only general questions can be recommended to a user, and questions specific to a product cannot be recommended to the user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Embodiments of the present disclosure provide a data processing method, an apparatus, a device, and a computer readable storage media, which are capable of constructing a candidate question set of a product object, and thereby capable of pushing a question of a candidate question set.

In implementations, the present disclosure provides a data processing method. The method includes selecting a first product object; determining one or more candidate product objects that are similar to the first product object; and constructing a set of candidate questions for the first product object based on existing user questions of the one or more candidate product objects.

In implementations, the present disclosure provides a data processing method. The method includes receiving an access request of a user for a question interface of a first product object; displaying the question interface; receiving a request for viewing questions in a candidate question set or a recommended question set of the first product object based on the question interface; receiving and displaying the questions in the candidate question set or the recommended question set of the first product object; and submitting a question selected by the user from the displayed questions.

In implementations, the present disclosure provides a data processing apparatus. The apparatus includes a selection module configured to select a first product object; a determination module configured to determine one or more candidate product objects that are similar to the first product object; and a first construction module configured to construct a set of candidate questions for the first product object based on existing user questions of the one or more candidate product objects.

In implementations, the present disclosure provides a data processing apparatus. The apparatus includes a first receiving unit configured to receive an access request of a user for a question interface of a first product object; a display unit configured to display the question interface; a second receiving unit configured to receive a request for viewing questions in a candidate question set or a recommended question set of the first product object based on the question interface; a third receiving unit configured to receive and display the questions in the candidate question set or the recommended question set of the first product object; and a submission unit configured to submit a question selected by the user from the displayed questions.

In implementations, the present disclosure provides a data processing device. The device includes memory and processor(s).

The memory is configured to store executable program codes.

The processor(s) is/are configured to read the executable program codes stored in the memory to perform the data processing method of the first aspect or the second aspect described above.

In implementations, the present disclosure provides a computer readable storage media, the computer readable storage media storing computer program instructions. The computer program instructions, when executed by processor(s), implement the data processing method of the first aspect or the second aspect.

The data processing method, apparatus, device and computer readable storage media of the embodiments of the present disclosure are capable of pushing a question. Since candidate product object(s) is/are similar to a first product object, a candidate question set and a recommended question set of the first product object are constructed based on existing user question set(s) of the candidate product object(s). Recommended questions can reflect concerns of other users on the product object.

### BRIEF DESCRIPTION OF THE DRAWINGS

In order to illustrate technical solutions of the embodiments of the present disclosure more clearly, drawings used in the embodiments of the present disclosure are briefly described herein. For one skilled in the art, other drawings can be obtained from these accompanying drawings without making any creative effort.

FIG. 1 is a schematic diagram showing a first process of a data processing method in accordance with the embodiments of the present disclosure.

FIG. 2 is a schematic diagram showing a second process of a data processing method in accordance with the embodiments of the present disclosure.

FIG. 3A is a schematic diagram showing a displayed question interface provided by the embodiments of the present disclosure.

FIG. 3B is a schematic diagram of a displayed recommended question interface provided by the embodiments of the present disclosure.

FIG. 4 is a schematic diagram of an application scenario of a data processing method in accordance with the embodiments of the present disclosure.

FIG. 5 is a schematic diagram showing a first structure of a data processing apparatus in accordance with the embodiments of the present disclosure.

FIG. 6 is a schematic diagram showing a second structure of a data processing apparatus in accordance with the embodiments of the present disclosure.

FIG. 7 is a block diagram showing a first exemplary hardware architecture of a computing device capable of implementing a data processing method in accordance with the embodiments of the present disclosure.

FIG. 8 shows a block diagram of a second exemplary hardware architecture of a computing device capable of implementing a data processing method in accordance with the embodiments of the present disclosure.

### DETAILED DESCRIPTION

Various features and exemplary embodiments of the present disclosure are described in detail hereinafter. In order to make the goals, the technical solutions and the advantages of the present disclosure more easily understood, the present disclosure is described in further detail hereinafter in conjunction with the accompanying drawings and the embodiments. It should be understood that the specific embodiments described herein are merely used for describing the present disclosure, and are not used for limiting the present disclosure. For one skilled in the art, the present disclosure can be implemented without the need of some details in these specific details. The description of the embodiments herein is merely used for the purpose of providing a better understanding of the present disclosure by illustrating examples of the present disclosure.

It should be noted that relational terms such as first and second in the present text are merely used for distinguishing one entity or operation from another entity or operation, and do not necessarily imply an existence of this type of relationship or order between these entities or operations in reality. Moreover, terms such as “include”, “contain” or any other variations thereof are intended to cover a non-exclusive inclusion. As such, a process, method, article or device including a series of elements not only includes these elements, but also includes other elements that are not explicitly listed, or elements that are inherent in the process, method, article or device. Without further limitation, an element defined by a phrase “including . . . ” does not exclude a process, method, article or device including this element from further including an addition of the same element.

In order to solve the existing problems, the embodiments of the present disclosure provide a data processing method, an apparatus, a device, and a computer readable storage media. The data processing method provided by the embodiments of the present disclosure is first introduced herein.

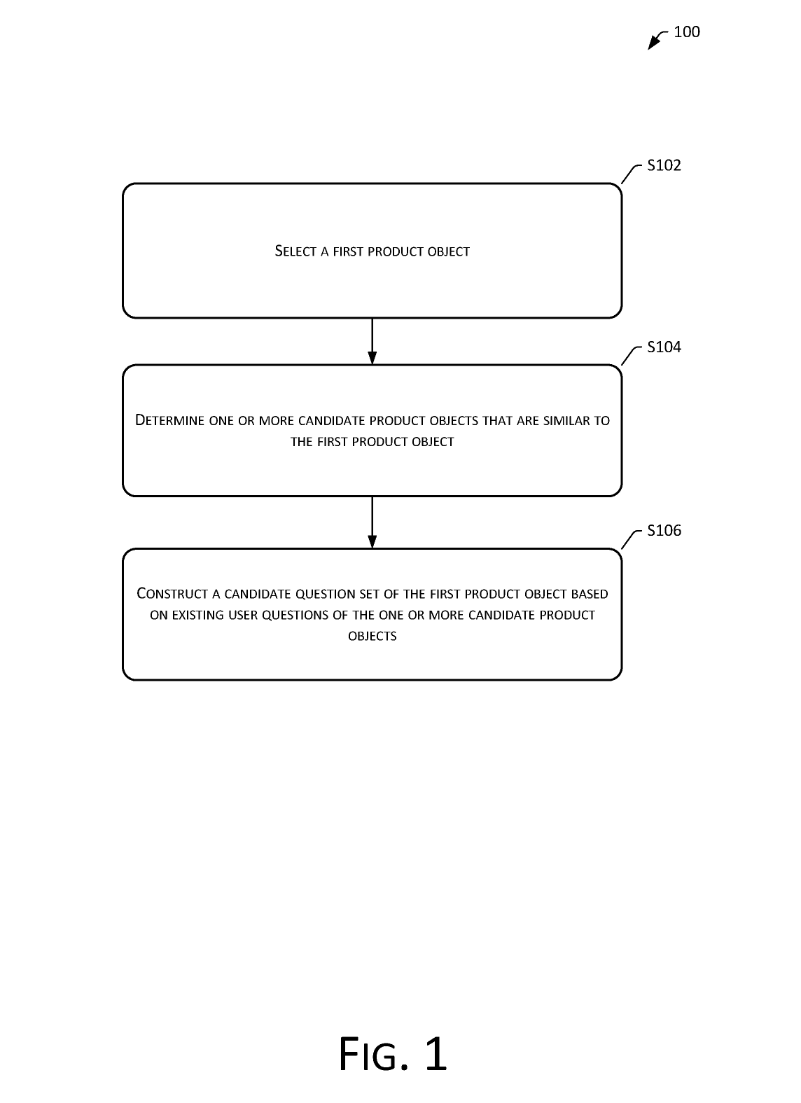

As shown in FIG. 1, FIG. 1 is a schematic diagram of a first process of a data processing method 100 according to the embodiments of the present disclosure, which may include:

S102: Select a first product object.

S104: Determine one or more candidate product objects that are similar to the first product object.

S106: Construct a candidate question set of the first product object based on existing user questions of the one or more candidate product objects.

In implementations, a candidate question set for a first product object is constructed based on existing user questions of one or more candidate product objects. Each existing user question of the one or more candidate product objects may be set as a question in the candidate question set for the first product object.

For example, a selected first product object is assumed to be a product object A. Candidate product objects that are determined to be similar to the product object A include a product object B, a product object C, and a product object D. A candidate question set for the product object A is constructed based on existing user questions of the product object B, the product object C, and the product object D.

Existing user questions of the product object B include a user question b1, a user question b2, and a user question b3.

Existing user questions of the product object C include a user question c1, a user question c2, a user question c3, and a user question c4.

Existing user questions of the product object D include a user question d1, a user question d2, a user question d3, a user question d4, and a user question d5.

Based on the existing user questions of the product object B, the product object C, and the product object D, the candidate question set of the product object A is constructed. The constructed candidate question set of the product object A may include 12 user questions, namely, the user question b1, the user question b2, the user question b3, the user question c1, the user question c2, the user question c3, the user question c4, the user question d1, the user question d2, the user question d3, the user question d4, and the user question d5.

When a user wants to ask questions about the product object A, these 12 user questions can be recommended to the user, and the user can select a question from among these 12 user questions to complete an inquiry for the product object A.

The data processing method of the embodiments of the present disclosure constructs a candidate problem set of a first product object by using existing user questions of other product objects, thereby being able to recommend questions of the candidate question set to the user. Since the candidate question set of the first product object is constructed based on the product objects that are similar to the first product object, the questions in the candidate question set of the first product object can reflect concerning points of other users about the product object.

In implementations, the data processing method provided by the embodiments of the present disclosure may further include calculating respective comprehensive feature scores of the questions in the candidate question set according to feature scores of one or more features of the existing user questions; and constructing a recommended question set for the first product object based on the respective comprehensive feature scores.

Specifically, constructing the recommended question set of the first product object based on the respective comprehensive feature scores may include sorting the questions in the candidate question set according to the respective comprehensive feature scores, and constructing the recommended question set of the first product object based on a result of the sorting; or setting a set constructed from questions corresponding to calculated comprehensive feature scores that are not less than a feature score threshold as the recommended question set of the first product object.

In implementations, the above features may include one or a combination of the following: respective degrees of similarity between candidate product objects corresponding to the existing user questions and the first product object, respective qualities of the existing user questions, respective answers of the existing user questions, respective degrees of concern of users in the existing user questions, and respective click rates of the existing user questions.

In implementations, a comprehensive feature score of the embodiments of the present disclosure may be equal to: W1*a similarity score of two product objects+W2*a quality score of a question+W3*an answer score of the question+W4*a degree of concern of the question+W5*a click rate of the question.

W1, W2, W3, W4 and W5 are respective weights corresponding to the similarity score of the two product objects, the quality score of the question, the answer score of the question, the degree of concern of the question, and the click rate of the question. W1, W2, W3, W4, and W5 can be preset, or can also be flexibly set according to actual needs. The questions can also be divided into positive samples and negative samples. Based on a learning to rank machine learning method and under the training of a RankSVM algorithm, each weight is obtained.

The similarity score of the two product objects may be a degree of similarity between word vectors of keyword sets of description information of the two product objects, and may also be a degree of similarity between pictures of the two product objects. The quality score of the question can be a score obtained by taking into account a length of a text of the question, whether the question contains attribute words (such as “hairy”, “leakage”, etc.), whether the question contains abusive words, and whether the question contains a question mark, etc. The answer score of the question can be a score obtained by considering the number of answers to the question and the number of persons who answer the question. The degree of concern of the question can be the number of times the question is liked or the number of times that the question is followed. The click rate of the question can be the number of times that the question is clicked/the total number of times that the question is clicked under the product object.

For example, the calculated comprehensive feature scores of the above 12 user questions are assumed to be 0.43, 0.55, 0.68, 0.87, 0.58, 0.7, 0.45, 0.95, 0.75, 0.85, 0.76, and 0.54 respectively.

In implementations, the above 12 user questions may be sorted according to the above-mentioned calculated comprehensive feature scores in a descending order. A sorting result is: the user question d1, the user question c1, the user question d3, the user question d4, the user question d2, the user question c3, the user question b3, the user question c2, the user question b2, the user question d5, the user question c4, the user question b1. The top 5 user questions in the sorting result are then selected to construct a recommended question set of the product object A. At this time, the recommended question set of the product object A may include five user questions, namely, the user question d1, the user question c1, the user question d3, the user question d4, and the user question d2.

In implementations, the feature score threshold may also be preset, for example, set to be 0.7. Then, a set constructed from questions corresponding to calculated comprehensive feature scores that are not less than 0.7 is taken as a recommended question set of the product object A. At this time, the recommended question set of the product object A may include six user questions, namely, the user question d1, the user question c1, the user question d3, the user question d4, the user question d2, and the user question c3.

It should be noted that a comprehensive feature score of the embodiments of the present disclosure being equal to W1*a similarity score of two product objects+W2*a quality score of a question+W3*an answer score of the question+W4*a degree of concern of the question+W5*a click rate of the question, is only a particular form of the embodiments of the present disclosure, and does not constitute as a limitation to the embodiments of the present disclosure. A comprehensive feature score of the embodiments of the present disclosure may also be equal to W1*a similarity score of two product objects+W4*a degree of concern of a question+W5*a click rate of the question, or may be equal to: W1*a similarity score of two product objects+W5*a click rate of a question, etc.

According to the data processing method of the embodiments of the present disclosure, the recommended question set of the first product object is constructed using the comprehensive feature scores of the questions, and thereby the questions of the recommended question set can be recommended to the user. The questions recommended to the user can further reflect a degree of concern of other users regarding the product object.

An abundant number of product objects exist in e-commerce settings. Some product objects have a lot of questions, some product objects have a few questions, and some product objects have no question. Accordingly, product objects having no question or product objects having a few questions can be selected. Candidate question sets or recommended questions sets are constructed for the product objects having no question or the product objects having a few questions.

In implementations, a product object having a number of existing user questions being less than a specific value may be selected to be the first product object.

For example, a product object with a number of questions being less than five is selected to be the first product object.

In implementations, the one or more candidate product objects that are similar to the first product object may be determined through a degree of similarity between word vectors. Specifically, description information of product objects is subjected to word segmentation processing to obtain respective keyword sets corresponding to the product objects. Product objects corresponding to word vector similarity degrees that are not less than a word vector similarity threshold are determined to be candidate product objects that are similar to the first product object from among word vector similarity degrees calculated based on the keyword sets.

In implementations, description information as described above may be a title of a product object, a name of the product object, parameter information of the product object, or the like. A word vector similarity degree as described above may be a Jaccard similarity coefficient. Word segmentation is a process of recombining consecutive word sequences into word sequences according to certain norms. The Jaccard similarity coefficient is a ratio between a size of an intersection of two sets and a size of a union of the two sets.

A title is used as an example of description information, and a Jaccard similarity coefficient is used as an example of a word vector similarity degree for explanation.

A title of the product object A is assumed to “dress spring and autumn style 2017 new fashion lace Korean version”. A title of the product object B is assumed to be “2017 spring and autumn style dress Korean version fashion lace”. A title of the product object C is assumed to be “Hengxingdao spring style new women contrast color v-neck t-shirt”. A title of the product object D is assumed to be “dress spring and autumn style 2017 new fashion lace Korean version.” A Jaccard similarity coefficient threshold is 0.5.

After performing word segmentation on the titles of the product object A, the product object B, the product object C, and the product object D respectively, keywords corresponding to the product object A are dress, spring and autumn style, 2017, new, fashion, lace, and Korean version. Keywords corresponding to the product object B are 2017, spring and autumn style, dress, Korean, fashion, and lace. Keywords corresponding to the product object C are Hengxingdao, spring style, new, women, contrast color, v-neck, and t-shirt. Keywords corresponding to the product object D are dress, spring and autumn style, 2017, new, fashion, lace, and Korean version. Therefore, corresponding keyword sets corresponding to the product object A, the product object B, the product object C, and the product object D are obtained respectively.

A keyword set corresponding to the product object A is {dress, spring and autumn style, 2017, new, fashion, lace, Korean version}. A keyword set corresponding to the product object B is {2017, spring and autumn style, dress, Korean version, fashion, lace}. A keyword set corresponding to the product object C is {Hengxingdao, spring style, new, women, contrast color, v-neck, t-shirt}. A keyword set corresponding to the product object D is {dress, spring and autumn style, 2017, new, fashion, lace, Korean version}.

Jaccard similarity coefficients of the keyword set corresponding to the product object A with respect to the keyword sets corresponding to the product object B, the product object C, and the product object D are calculated respectively. The calculated Jaccard similarity coefficients of the keyword set corresponding to the product object A with respect to the keyword sets corresponding to the product object B, the product object C, and the product object D are 0.85, 0.07, and 1 respectively.

The product object B and the product object D are then determined to be candidate product objects that are similar to the product object A.

It should be noted that the embodiments of the present disclosure do not have any limitations on algorithms used in a process of word segmentation, and any word segmentation algorithm can be applicable to the embodiments of the present disclosure.

A product object sold by a merchant generally has a corresponding picture, and a buyer can have a most intuitive understanding of the product object through the picture of the product object. Therefore, pictures of product objects can also be used for determining candidate product objects.

In implementations, from among picture similarities of other product objects with respect to the first product object, product object(s) corresponding to picture similarit(ies) that is/are not less than a picture similarity threshold may be determined as candidate product object(s) similar to the first product object.

For example, a degree of similarity between a picture of the product object A and a picture of the product object B is assumed to be 0.85. A degree of similarity between a picture of the product object A and a picture of the product object C is assumed to be 0.05. A degree of similarity between a picture of the product object A and a picture of the product object D is assumed to be 1. A picture similarity threshold is 0.8.

The product object B and the product object D are then determined as candidate product objects similar to the product object A.

It should be noted that the embodiments of the present disclosure do not have any limitations on algorithms used for calculating a degree of similarity between pictures, and any algorithm that calculates a degree of similarity between pictures are applicable to the embodiments of the present disclosure.

In implementations, the data processing method of the embodiments of the present disclosure may further include storing the questions in the candidate question set or the recommended question set of the first product object.

In implementations, the questions in the candidate question set of the first product object or the recommended question set may be stored in a data table that separately corresponds to the first product object, or may be stored in a data table that is used for storing questions in candidate question sets or recommended question sets of all product objects. The above data table may be an EXCEL table or a table in a database.

In implementations, the questions in the candidate question set or the recommended question set may also be sorted according to magnitudes of the comprehensive feature scores, and the questions are stored according to a sorting result.

It can be understood that recommending existing user questions of product objects that are not similar to the first product object to the user not only fails to meet the needs of the user (i.e., the questions that are recommended cannot reflect a point of concern of the user with respect to the product object itself), but also affects effects of experience of the user. For example, the first product object is clothing, and the user's needs cannot be satisfied and the user experience is affected if existing user questions of product objects such as a bicycle, a household appliance, a mobile phone, etc., are recommended. Accordingly, questions of product objects that are similar to the first product object are needed to be recommended to the user.

It should be noted that the product object A, the product object B, the product object C, and the product object D are used as examples for explanation, and are only specific examples of the embodiments of the present disclosure, which do not constitute as a limitation of the embodiments of the present disclosure.

The data processing method of the embodiments of the present disclosure constructs a candidate question set of a first product object using existing user questions of other product objects, and is thereby able to recommend questions of the candidate problem set to a user. Moreover, since the candidate question set of the first product object is constructed based on product objects that are similar to the first product object, the questions in the candidate question set of the first product object can reflect points of concern of other users with respect to the product object. Furthermore, a recommended question set of the first product object is constructed using comprehensive feature scores of the questions, and thus questions in the recommended question set can be recommended to the user. The questions recommended to the user can further reflect the points of concern of the other users with respect to the product object.

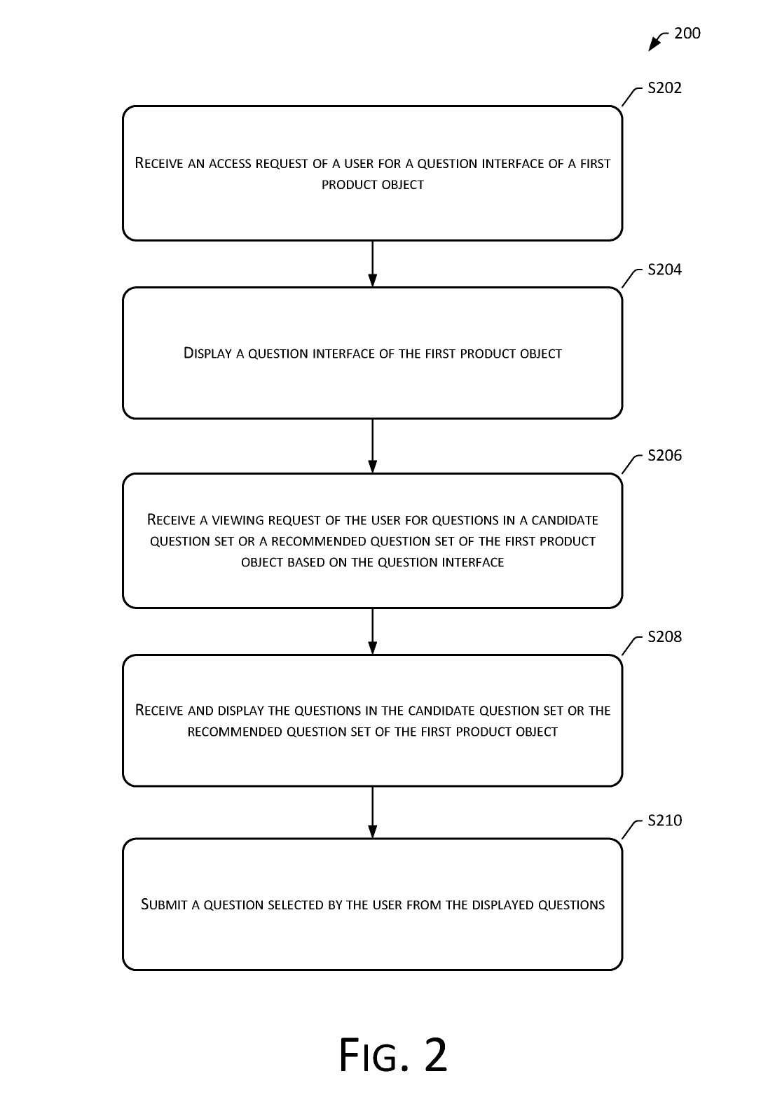

FIG. 2 is a schematic diagram showing a second process of a data processing method 200 according to the embodiments of the present disclosure, which may include:

S202: Receive an access request of a user for a question interface of a first product object.

S204: Display a question interface of the first product object.

S206: Receive a viewing request of the user for questions in a candidate question set or a recommended question set of the first product object based on the question interface.

S208: Receive and display the questions in the candidate question set or the recommended question set of the first product object.

S210: Submit a question selected by the user from the displayed questions.

The data processing method provided by the embodiments of the present disclosure is described hereinafter in conjunction with a specific illustration.

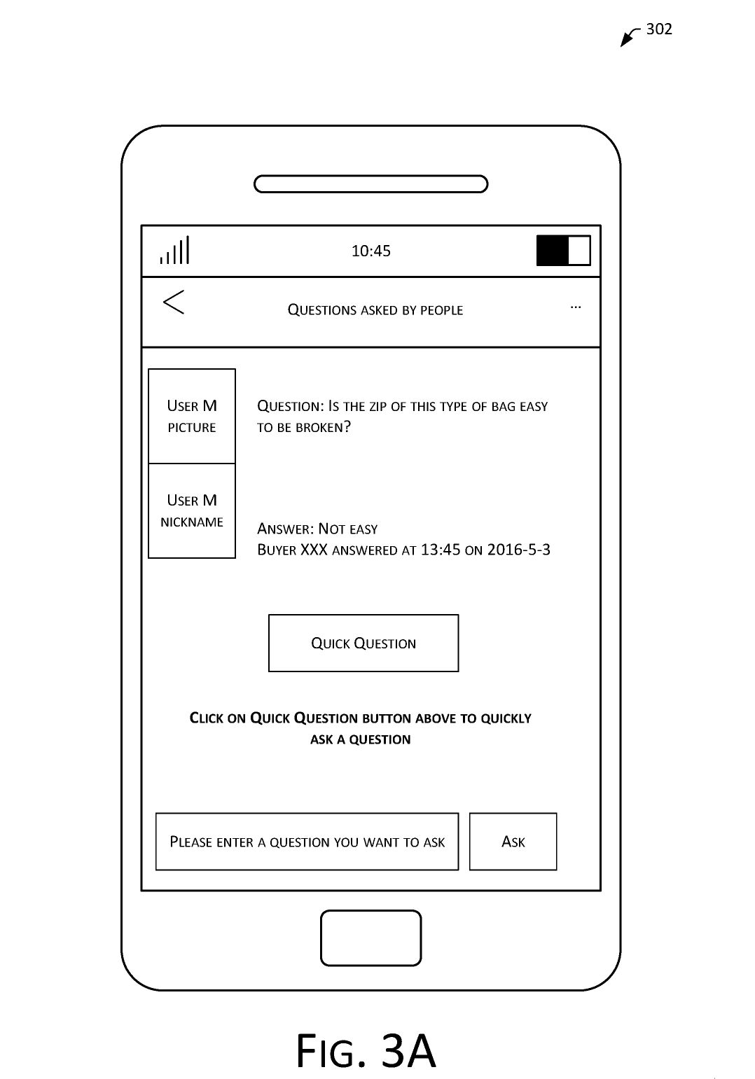

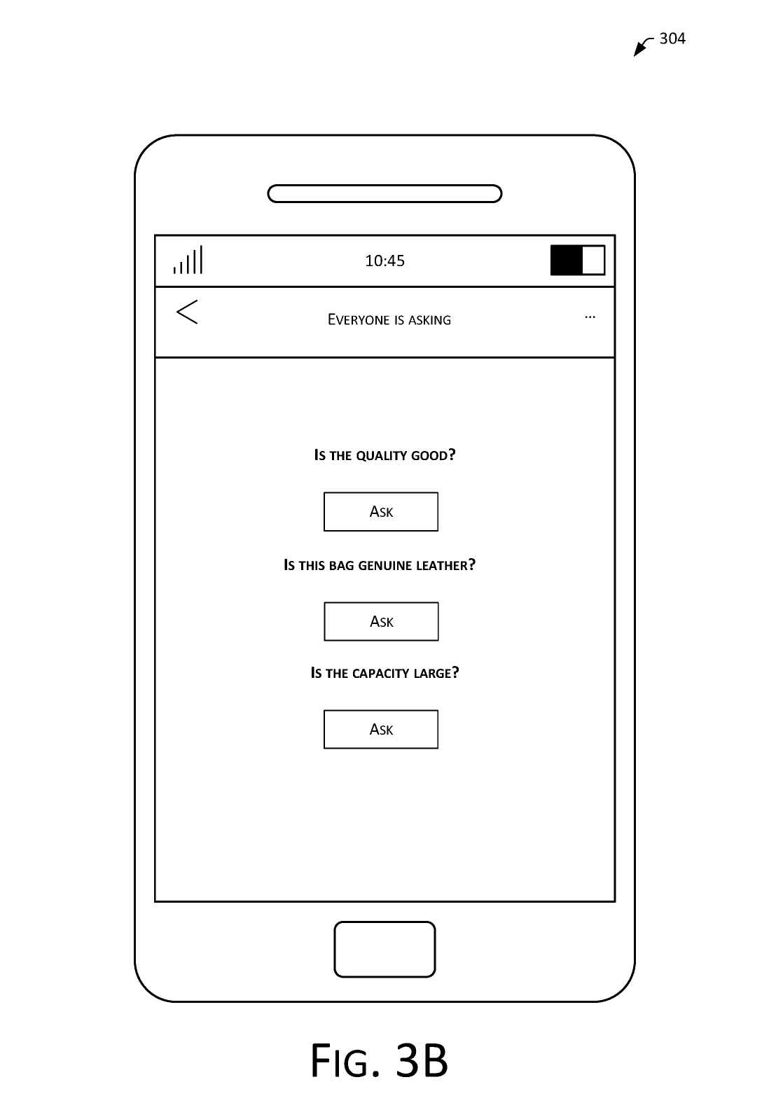

For example, the first product object is assumed to be a certain leather bag. When a user wants to browse other users' questions and answers about the leather bag, a request is made to access a question interface associated with the leather bag. After the user's request is received, an interface is displayed as shown in FIG. 3A. FIG. 3A is a schematic diagram of a displayed question interface 302 provided by the embodiments of the present disclosure. FIG. 3A shows a question raised by a user M regarding the leather bag as well as an answer of the question from a person XXX who has made a purchase. FIG. 3A also shows an entry that the user can quickly submit a question. The user can manually enter an entry through which a question is submitted. Through the entry for quick question in FIG. 3A, a request for viewing questions in a candidate question set or a recommended problem set of the leather bag from the user. When the user clicks on “quick question” in FIG. 3A, the request for viewing the questions in the candidate question set or the recommended question set of the leather bag is sent. The questions in the candidate question set or the recommended question set of the leather bag are received and displayed. An interface after the questions are displayed is shown in FIG. 3B. FIG. 3B shows a schematic diagram of a displayed recommended question interface 304 provided by the embodiments of the present disclosure. The questions in the candidate question set or the recommended question set shown in FIG. 3B are, namely, “Is the quality good?”, “Is this bag genuine leather?” and “Is the capacity large?”. When the user clicks on “ask” corresponding to the above question, the question is then submitted and asked.

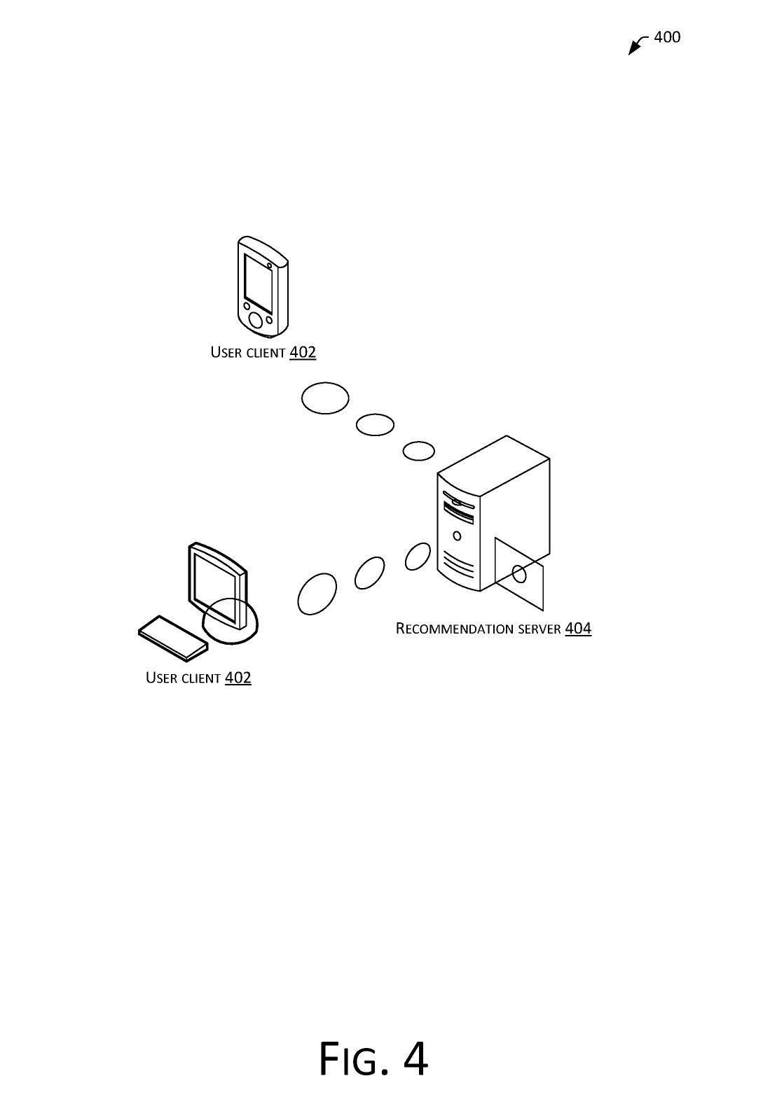

FIG. 4 is a schematic diagram of an application scenario 400 of a data processing method according to the embodiments of the present disclosure. The application scenario 400 may include a user client 402 and a recommendation server 404. The user client 402 is coupled to the recommendation server. One or more user clients 402 may exist in the application scenario 400.

In implementations, the user client 402 may be a mobile device, for example, may be a mobile phone, a tablet, or the like. The user client 402 may also be a desktop device, such as an all-in-one computer, a computer, or the like.

In implementations, the recommendation server 404 may select a first product object in advance, determine one or more candidate product objects that are similar to the first product object, and construct a candidate question set of the first product object based on existing user questions of the one or more candidate product objects. The recommendation server 404 may further construct a recommended question set of the first product object.

A process in which the recommendation server 404 constructs the candidate question set and the recommended question set of the product object may refer to the process of constructing the candidate question set and the recommended question set in the data processing method of the embodiments of the present disclosure as shown in FIG. 1, and is not repeatedly described herein in the embodiments of the present disclosure.

For example, the selected first product object is assumed to be a certain leather bag. A candidate question set is constructed for this leather bag, and the candidate question set includes three user questions, namely, “Is the quality good?”, “Is this bag is genuine leather?” and “Is the capacity big?”.

When a user logs into an e-commerce platform through the user client 402 to access this leather bag, and enters a question interface corresponding to the bag, a question interface as shown in FIG. 3A is displayed. When the user clicks “quick question” in FIG. 3A, a question asking interface as shown in FIG. 3B is displayed. When the user clicks on “ask” corresponding to a certain question in FIG. 3B, such question is then submitted and asked.

In implementations, based on comprehensive feature scores of questions, the questions may be recommended according to magnitudes of the comprehensive feature scores when recommendation of the questions is performed. Specifically, when questions are displayed by the user client 402, the questions may be displayed in a sorted order according to the magnitudes of the comprehensive feature scores. The questions may also be displayed in different character sizes according to the magnitudes of the comprehensive feature scores, etc.

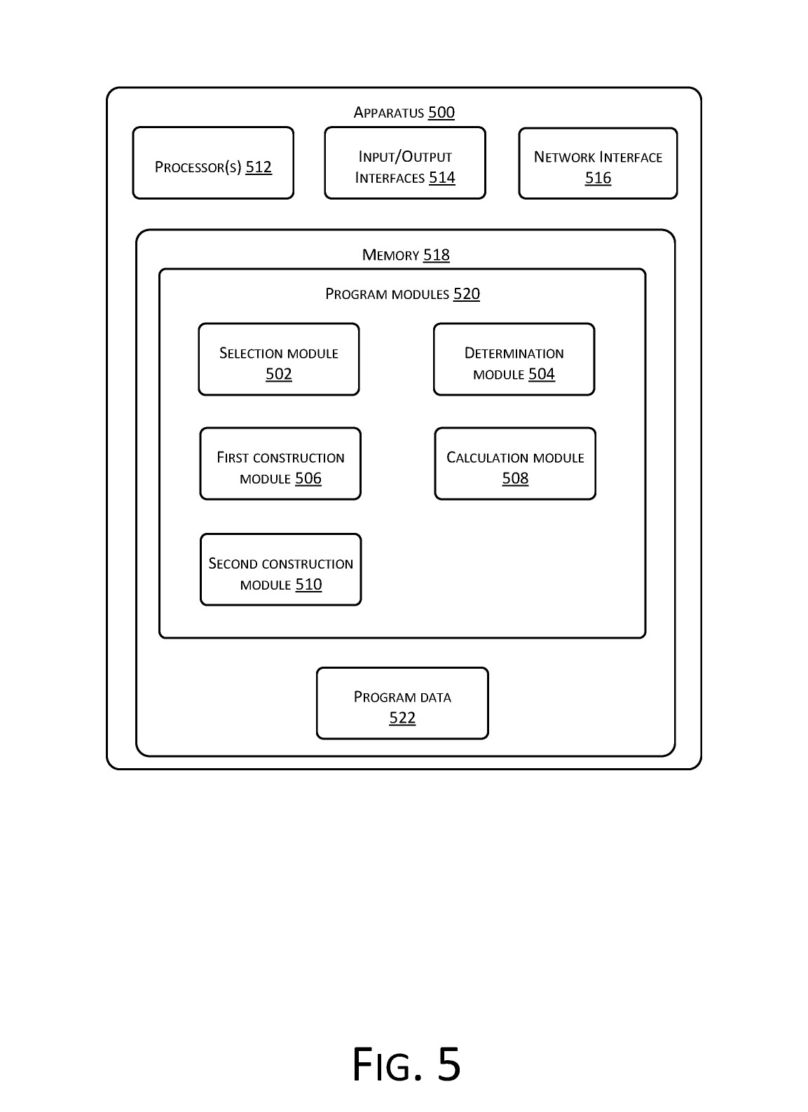

FIG. 5 shows a schematic structural diagram of a first data processing apparatus 500 according to the embodiments of the present disclosure. In implementations, the apparatus 500 may include one or more computing devices. In implementations, the apparatus 500 may be a part of one or more computing devices, e.g., implemented or run by the one or more computing devices. In implementations, the one or more computing devices may be located in a single place or distributed among a plurality of network devices over a network. By way of example and not limitation, the apparatus 500 may include a selection module 502 configured to select a first product object; a determination module 504 configured to determine one or more candidate product objects that are similar to the first product object; and a first construction module 506 configured to construct a candidate question set of the first product object based on existing user questions of the one or more candidate product objects.

In implementations, the data processing apparatus 500 may further include a calculation module 508 configured to calculate comprehensive feature scores of questions in the candidate question set according to characteristic scores of one or more features of the existing user questions; and a second construction module 510 configured to construct a recommended question set of the first product object based on the comprehensive feature scores.

In implementations, the second construction module 510 may be further configured to sort the questions in the candidate question set according to the comprehensive feature scores, and construct the recommended question set of the first product object based on a sorting result; or use a set constructed from questions corresponding to calculated comprehensive feature scores that are not less than a feature score threshold as the recommended question set of the first product object.

In implementations, the above features may include one or a combination of the following: respective degrees of similarity between candidate product objects corresponding to the existing user questions and the first product object, respective qualities of the existing user questions, respective answers of the existing user questions, respective degrees of concern of users in the existing user questions, and respective click rates of the existing user questions.

In implementations, the determination module 504 is further configured to perform word segmentation processing on description information of the product objects to obtain keyword sets corresponding to the product objects; and determine product object(s) corresponding to word vector similarity degree(s) that is/are not less than a word vector similarity threshold to be candidate product object(s) similar to the first product object from among word vector similarity degrees that are calculated based on the keyword sets.

In implementations, the word vector similarity degree may be a Jaccard similarity coefficient.

In implementations, the determination module 504 is specifically configured to determine, from among picture similarities of other product objects with respect to the first product object, product object(s) corresponding to picture similarit(ies) that is/are not less than a picture similarity threshold as candidate product object(s) similar to the first product object.

In implementations, the data processing apparatus of the embodiments of the present disclosure may further include a storage module configured to store the questions in the candidate question set or the recommended question set of the first product object.

In implementations, the apparatus 500 may further include one or more processors 512, an input/output (I/O) interface 514, a network interface 516, and memory 518.

The memory 518 may include a form of computer readable media such as a volatile memory, a random access memory (RAM) and/or a non-volatile memory, for example, a read-only memory (ROM) or a flash RAM. The memory 518 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 518 may include program modules 520 and program data 522. The program modules 520 may include one or more of the modules as described in the foregoing description and shown in FIG. 5.

Details of various parts of the data processing apparatus shown in FIG. 5 are similar to the data processing method of the embodiments of the present disclosure shown in FIG. 1, and are not repeatedly described herein in the embodiments of the present disclosure.

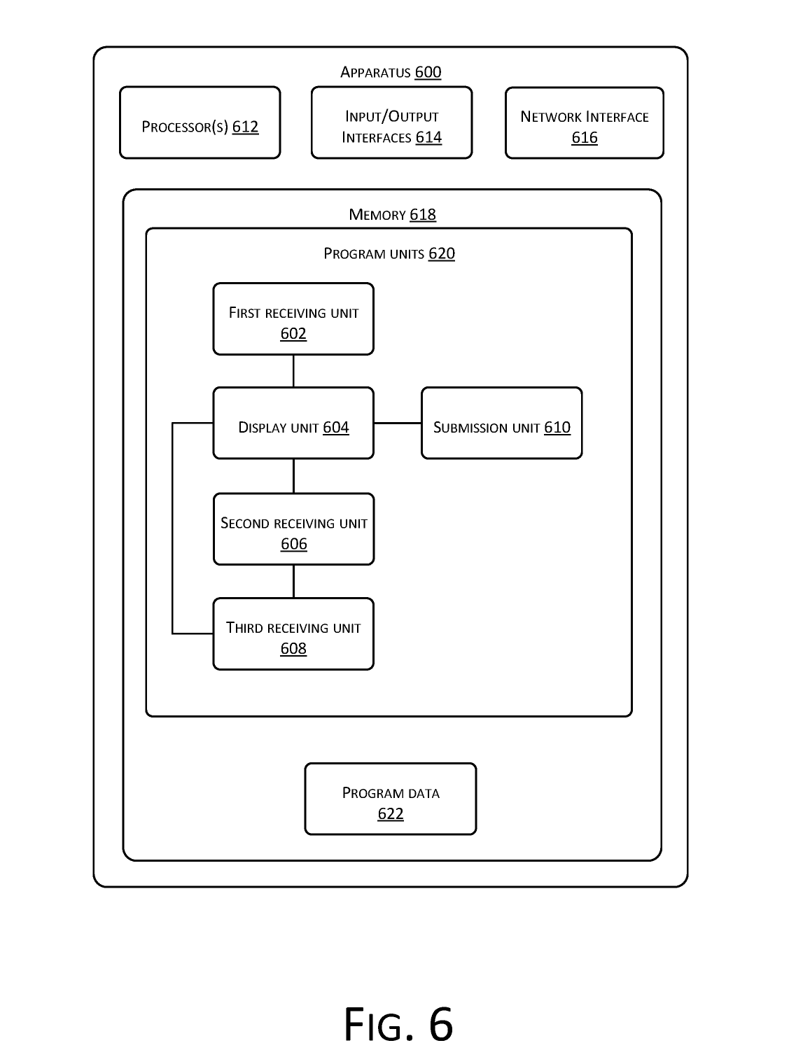

FIG. 6 shows a schematic structural diagram showing a second data processing apparatus 600 according to the embodiments of the present disclosure, which may include a first receiving unit 602 configured to receive a request of a user for accessing a question interface of a first product object; a display unit 604 configured to display a question interface and display questions in a candidate question set or a recommended question set of the first product object; a second receiving unit 606 configured to receive a request of the user for viewing the questions in the candidate question set or the recommended question set according to the question interface; a third receiving unit 608 configured to receive the questions in a candidate question set or the recommended question set; and a submission unit 610 configured to submit a question selected by the user from the displayed questions.

In implementations, the apparatus 600 may further include one or more processors 612, an input/output (I/O) interface 614, a network interface 616, and memory 618.

In implementations, the memory 618 may include program units 620 and program data 622. The program units 620 may include one or more of the modules as described in the foregoing description and shown in FIG. 6.

Details of various parts of the data processing apparatus shown in FIG. 6 are similar to the data processing method of the embodiments of the present disclosure shown in FIG. 2, and are not repeatedly described herein in the embodiments of the present disclosure.

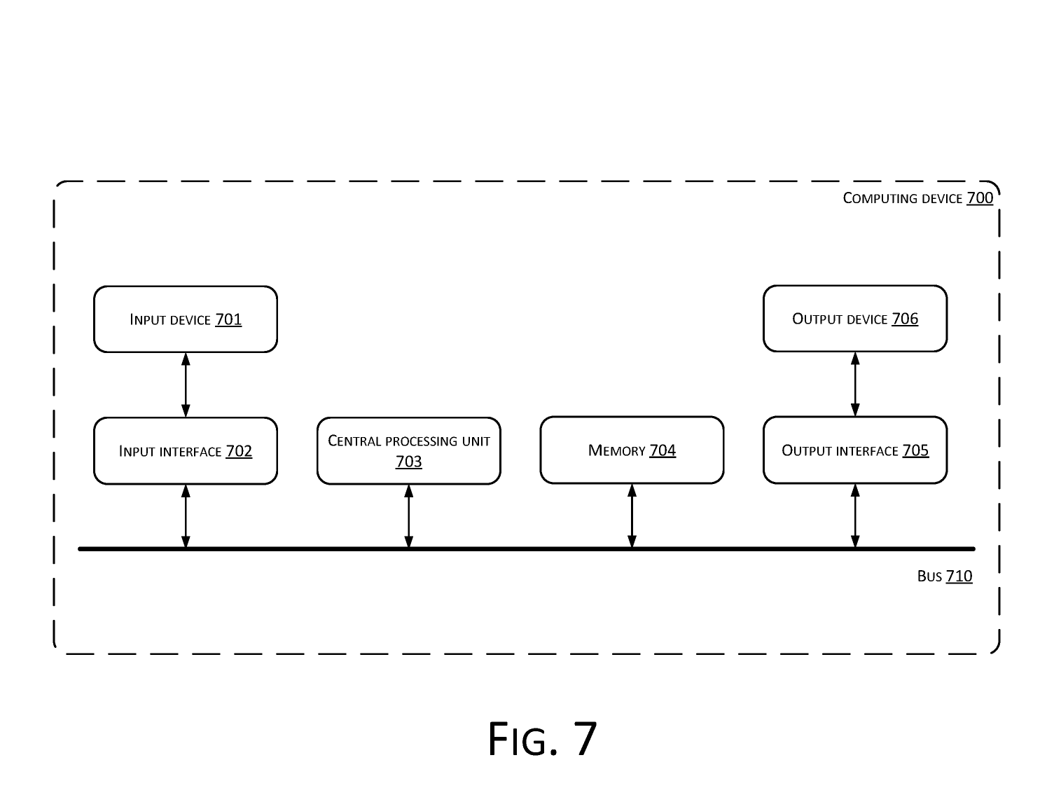

FIG. 7 shows a block diagram of a first exemplary hardware architecture of a computing device 700 capable of implementing a data processing method in accordance with the embodiments of the present disclosure.

As shown in FIG. 7, a computing device 700 includes an input device 701, an input interface 702, a central processing unit 703, memory 704, an output interface 705, and an output device 706. The input interface 702, the central processing unit 703, the memory 704, and the output interface 705 are connected to each other through a bus 710. The input device 701 and the output device 706 are connected to the bus 710 through the input interface 702 and the output interface 705 respectively, and thereby connected to other components of the computing device 700.

Specifically, the input device 701 receives input information from the outside and transmits the input information to the central processing unit 703 via the input interface 702. The central processing unit 703 processes the input information based on computer executable instructions stored in memory 704 to generate output information, stores the output information temporarily or permanently in the memory 704, and transmits the output information to the output device 706 via the output interface 705. The output device 706 outputs the output information to the outside of the computing device 700 for use by a user.

In other words, the computing device shown in FIG. 7 can also be implemented as a data processing device. The data processing device may include memory storing computer executable instructions, and processor(s) implementing the data processing method described in FIG. 1 when executing the computer executable instructions.

The embodiments of the present disclosure further provide a computer readable storage media having stored computer program instructions thereon, the computer program instructions, when executed by processor(s), implementing the data processing method described in FIG. 1 of the embodiments of the present disclosure.

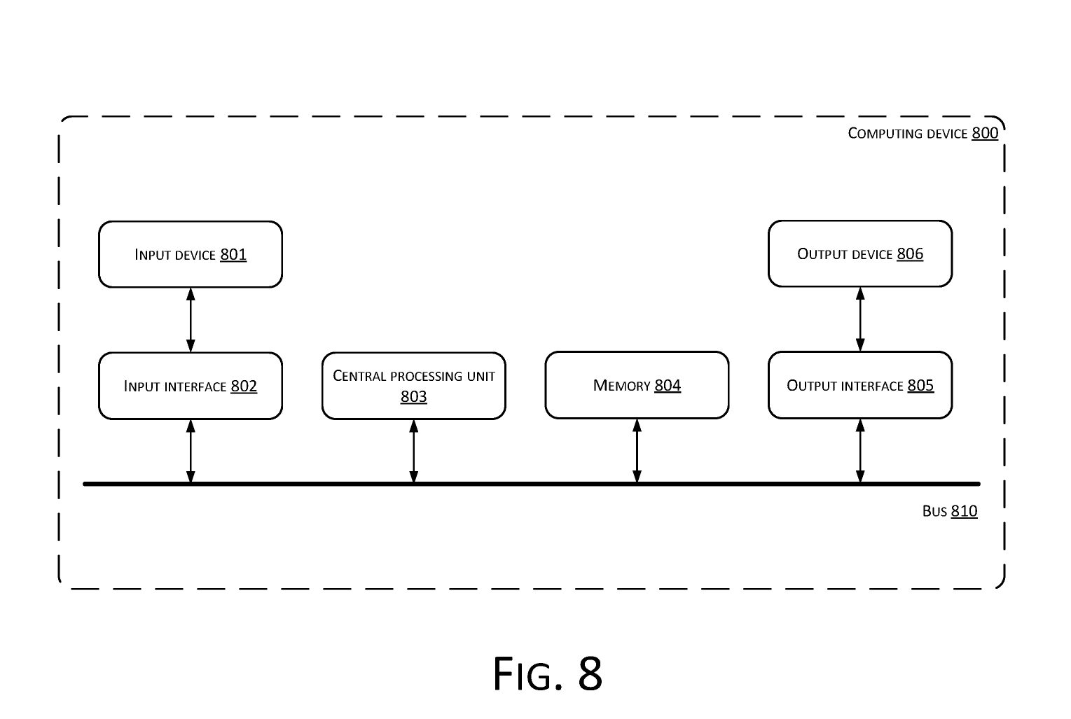

FIG. 8 shows a block diagram of a second exemplary hardware architecture of a computing device 800 capable of implementing a data processing method in accordance with the embodiments of the present disclosure.

As shown in FIG. 8, a computing device 800 includes an input device 801, an input interface 802, a central processing unit 803, memory 804, an output interface 805, and an output device 806. The input interface 802, the central processing unit 803, the memory 804, and the output interface 805 are connected to each other through a bus 810. The input device 801 and the output device 806 are connected to the bus 810 through the input interface 802 and the output interface 805 respectively, and thereby connected to other components of the computing device 800.

Specifically, the input device 801 receives input information from the outside and transmits the input information to the central processing unit 803 via the input interface 802. The central processing unit 803 processes the input information based on computer executable instructions stored in memory 804 to generate output information, stores the output information temporarily or permanently in the memory 804, and transmits the output information to the output device 806 via the output interface 805. The output device 806 outputs the output information to the outside of the computing device 800 for use by a user.

In other words, the computing device shown in FIG. 8 can also be implemented as a data processing device. The data processing device may include memory storing computer executable instructions, and processor(s) implementing the data processing method described in FIG. 1 when executing the computer executable instructions.

The embodiments of the present disclosure further provide a computer readable storage media having stored computer program instructions thereon, the computer program instructions, when executed by processor(s), implementing the data processing method described in FIG. 2 of the embodiments of the present disclosure.

It should be clear that the present disclosure is not limited to the specific configurations and processes described in the foregoing text and shown in the figures. For the sake of brevity, a detailed description of known methods is omitted herein. In the embodiments described above, a number of specific steps have been described and illustrated as examples. However, the processes of the methods of the present disclosure are not limited to these specific steps that are described and shown. After understanding the spirit of the present disclosure, one skilled in the art can make various changes, modifications and additions thereto, or changes to orders of the steps.

The functional blocks shown in the block diagrams described above may be implemented as hardware, software, firmware, or a combination thereof. When implemented in hardware, it may be, for example, an electronic circuit, an application specific integrated circuit (ASIC), suitable firmware, a plug-in, a functional card, and the like. When implemented in software, the elements of the present disclosure are programs or code segments that are used for performing the required tasks. The programs or code segments may be stored in a machine-readable media or transmitted over a transmission media or communication link via a data signal carried in a carrier wave. The “machine-readable media” may include any media that is capable of storing or transmitting information. Examples of the machine-readable media include an electronic circuit, a semiconductor memory device, a ROM, a flash memory, an erasable ROM (EROM), a floppy disk, a CD-ROM, an optical disk, a hard disk, a fiber optic media, a radio frequency (RF) link, and the like. The code segments may be downloaded via a computer network such as the Internet, an intranet, or the like.

It should also be noted that the exemplary embodiments mentioned in the present disclosure describe some methods or systems based on a series of steps or apparatuses. However, the present disclosure is not limited to the orders of the above steps. In other words, the steps may be performed in the orders mentioned in the embodiments, or may be different from the orders in the embodiments. Alternatively, a number of steps may be performed simultaneously.

The foregoing descriptions are merely specific implementations of the present disclosure. One skilled in the art can clearly understand that specific working processes of the above-described systems, modules and units may refer to corresponding processes of the foregoing method embodiments for the convenience and conciseness of description, and are not repeatedly described herein. It should be understood that the scope of protection of the present disclosure is not limited thereto. Any person skilled in the art can easily conceive various equivalent modifications or replacements within the technical scope disclosed by the present disclosure. These modifications or replacements should be covered in the scope of protection of the present disclosure.

The present disclosure can be further understood using the following clauses.

Clause 1: A data processing method comprising: selecting a first product object; determining one or more candidate product objects that are similar to the first product object; and constructing a set of candidate questions for the first product object based on existing user questions of the one or more candidate product objects.

Clause 2: The method of Clause 1, further comprising: calculating comprehensive feature scores of questions in the candidate question set according to characteristic scores of one or more features of the existing user questions; and constructing a recommended question set of the first product object based on the comprehensive feature scores.

Clause 3: The method of Clause 2, wherein constructing the recommended question set of the first product object based on the comprehensive feature scores comprises: sorting the questions in the candidate question set according to the comprehensive feature scores, and construct the recommended question set of the first product object based on a sorting result; or using a set constructed from questions corresponding to calculated comprehensive feature scores that are not less than a feature score threshold as the recommended question set of the first product object.

Clause 4: The method of Clause 2, wherein the features comprise one or a combination of the following: respective degrees of similarity between candidate product objects corresponding to the existing user questions and the first product object, respective qualities of the existing user questions, respective answers of the existing user questions, respective degrees of concern of users in the existing user questions, and respective click rates of the existing user questions.

Clause 5: The method of Clause 1, wherein determining the one or more candidate product objects that are similar to the first product object comprises: performing word segmentation processing on description information of the product objects to obtain keyword sets corresponding to the product objects; and determining product object(s) corresponding to word vector similarity degree(s) that is/are not less than a word vector similarity threshold to be candidate product object(s) similar to the first product object from among word vector similarity degrees that are calculated based on the keyword sets.

Clause 6: The method of Clause 5, wherein the word vector similarity degree comprises a Jaccard similarity coefficient.

Clause 7: The method of Clause 1, wherein determining the one or more candidate product objects that are similar to the first product object comprises determining, from among picture similarities of other product objects with respect to the first product object, product object(s) corresponding to picture similarit(ies) that is/are not less than a picture similarity threshold as candidate product object(s) similar to the first product object.

Clause 8: The method of any one of Clauses 1-7, further comprising storing questions in the candidate question set or the recommended question set of the first product object.

Clause 9: A data processing method comprising: receiving an access request of a user for a question interface of a first product object; displaying the question interface; receiving a request for viewing questions in a candidate question set or a recommended question set of the first product object based on the question interface; receiving and displaying the questions in the candidate question set or the recommended question set of the first product object; and submitting a question selected by the user from the displayed questions.

Clause 10: A data processing apparatus comprising: a selection module configured to select a first product object; a determination module configured to determine one or more candidate product objects that are similar to the first product object; and a first construction module configured to construct a set of candidate questions for the first product object based on existing user questions of the one or more candidate product objects.

Clause 11: The apparatus of Clause 10, further comprising: a calculation module configured to calculate comprehensive feature scores of questions in the candidate question set according to characteristic scores of one or more features of the existing user questions; and a second construction module configured to construct a recommended question set of the first product object based on the comprehensive feature scores.

Clause 12: The apparatus of Clause 11, wherein the second construction module is specifically configured to sort the questions in the candidate question set according to the comprehensive feature scores, and construct the recommended question set of the first product object based on a sorting result; or use a set constructed from questions corresponding to calculated comprehensive feature scores that are not less than a feature score threshold as the recommended question set of the first product object.

Clause 13: The apparatus of Clause 11, wherein the features comprise one or a combination of the following: respective degrees of similarity between candidate product objects corresponding to the existing user questions and the first product object, respective qualities of the existing user questions, respective answers of the existing user questions, respective degrees of concern of users in the existing user questions, and respective click rates of the existing user questions.

Clause 14: The apparatus of Clause 10, wherein the determination module is specifically configured to: perform word segmentation processing on description information of the product objects to obtain keyword sets corresponding to the product objects; and determine product object(s) corresponding to word vector similarity degree(s) that is/are not less than a word vector similarity threshold to be candidate product object(s) similar to the first product object from among word vector similarity degrees that are calculated based on the keyword sets.

Clause 15: The apparatus of Clause 14, wherein the word vector similarity degree comprises a Jaccard similarity coefficient.

Clause 16: The apparatus of Clause 10, wherein the determination module is specifically configured to determine, from among picture similarities of other product objects with respect to the first product object, product object(s) corresponding to picture similarit(ies) that is/are not less than a picture similarity threshold as candidate product object(s) similar to the first product object.

Clause 17: The apparatus of any one of Clauses 10-16, further comprising a storage module configured to store questions in the candidate question set or the recommended question set of the first product object.

Clause 18: A data processing apparatus comprising: a first receiving unit configured to receive an access request of a user for a question interface of a first product object; a display unit configured to display the question interface; a second receiving unit configured to receive a request for viewing questions in a candidate question set or a recommended question set of the first product object based on the question interface; a third receiving unit configured to receive and display the questions in the candidate question set or the recommended question set of the first product object; and a submission unit configured to submit a question selected by the user from the displayed questions.

Clause 19: A data processing device comprising: memory, and a processor, the memory configured to store executable program codes, and the processor configured to read the executable program codes stored in the memory to perform the data processing method of any one of Clauses 1-8.

Clause 20: A data processing device comprising: memory, and a processor, the memory configured to store executable program codes, and the processor configured to read the executable program codes stored in the memory to perform the data processing method of Clause 9.

Clause 21: A computer readable storage media, wherein the computer readable storage media stores computer program instructions, the computer program instructions, when executed by a processor, implementing the data processing method of any one of Clauses 1-8.

Clause 22: A computer readable storage media, wherein the computer readable storage media stores computer program instructions, the computer program instructions, when executed by a processor, implementing the data processing method of Clause 9.

What is claimed is:

1. A method implemented by one or more computing device, the method comprising:
selecting a first product object;
determining one or more candidate product objects that are similar to the first product object; and
constructing a set of candidate questions for the first product object based on existing user questions of the one or more candidate product objects.

2. The method of claim 1, further comprising:
calculating comprehensive feature scores of questions in the candidate question set according to characteristic scores of one or more features of the existing user questions; and
constructing a recommended question set of the first product object based on the comprehensive feature scores.

3. The method of claim 2, wherein constructing the recommended question set of the first product object based on the comprehensive feature scores comprises sorting the questions in the candidate question set according to the comprehensive feature scores, and constructing the recommended question set of the first product object based on a sorting result.

4. The method of claim 2, wherein constructing the recommended question set of the first product object based on the comprehensive feature scores comprises using a set constructed from questions corresponding to calculated comprehensive feature scores that are not less than a feature score threshold as the recommended question set of the first product object.

5. The method of claim 2, wherein the features comprise one or a combination of the following: respective degrees of similarity between candidate product objects corresponding to the existing user questions and the first product object, respective qualities of the existing user questions, respective answers of the existing user questions, respective degrees of concern of users in the existing user questions, and respective click rates of the existing user questions.

6. The method of claim 1, wherein determining the one or more candidate product objects that are similar to the first product object comprises:
performing word segmentation processing on description information of the product objects to obtain keyword sets corresponding to the product objects; and
determining one or more product objects corresponding to one or more word vector similarity degrees that are not less than a word vector similarity threshold to be one or more candidate product objects similar to the first product object from among word vector similarity degrees that are calculated based on the keyword sets.

7. The method of claim 6, wherein a word vector similarity degree of the one or more word vector similarity degrees comprises a Jaccard similarity coefficient.

8. The method of claim 1, wherein determining the one or more candidate product objects that are similar to the first product object comprises determining, from among picture similarities of other product objects with respect to the first product object, one or more product objects corresponding to one or more picture similarities that are not less than a picture similarity threshold as one or more candidate product objects similar to the first product object.

9. The method of claim 1, further comprising storing questions in the candidate question set or the recommended question set of the first product object.

10. An apparatus comprising:
one or more processors;
memory;
a selection module stored in the memory and executable by the one or more processors to select a first product object;
a determination module stored in the memory and executable by the one or more processors to determine one or more candidate product objects that are similar to the first product object; and
a first construction module stored in the memory and executable by the one or more processors to construct a set of candidate questions for the first product object based on existing user questions of the one or more candidate product objects.

11. The apparatus of claim 10, further comprising a calculation module configured to calculate comprehensive feature scores of questions in the candidate question set according to characteristic scores of one or more features of the existing user questions.

12. The apparatus of claim 11, wherein the features comprise one or more of: respective degrees of similarity between candidate product objects corresponding to the existing user questions and the first product object, respective qualities of the existing user questions, respective answers of the existing user questions, respective degrees of concern of users in the existing user questions, and respective click rates of the existing user questions.

13. The apparatus of claim 10, further comprising a second construction module configured to construct a recommended question set of the first product object based on the comprehensive feature scores.

14. The apparatus of claim 13, wherein the second construction module is further configured to sort the questions in the candidate question set according to the comprehensive feature scores, and construct the recommended question set of the first product object based on a sorting result; or use a set constructed from questions corresponding to calculated comprehensive feature scores that are not less than a feature score threshold as the recommended question set of the first product object.

15. The apparatus of claim 10, wherein the determination module is further configured to:
perform word segmentation processing on description information of the product objects to obtain keyword sets corresponding to the product objects; and
determine one or more product objects corresponding to one or more word vector similarity degrees that are not less than a word vector similarity threshold to be one or more candidate product objects similar to the first product object from among word vector similarity degrees that are calculated based on the keyword sets.

16. The apparatus of claim 15, wherein a word vector similarity degree of the one or more word vector similarity degrees comprises a Jaccard similarity coefficient.

17. The apparatus of claim 10, wherein the determination module is further configured to determine, from among picture similarities of other product objects with respect to the first product object, one or more product objects corresponding to one or more picture similarities that are not less than a picture similarity threshold as one or more candidate product objects similar to the first product object.

18. The apparatus of claim 10, further comprising a storage module configured to store questions in the candidate question set or the recommended question set of the first product object.

19. One or more computer readable media storing executable instructions that, when executed by one or more processors, cause the one or more processors to perform acts comprising:
receiving an access request of a user for a question interface of a first product object;
displaying the question interface;
receiving a request for viewing questions in a candidate question set or a recommended question set of the first product object based on the question interface;
receiving and displaying the questions in the candidate question set or the recommended question set of the first product object; and
submitting a question selected by the user from the displayed questions.

20. The one or more computer readable media of claim 19, wherein the questions comprises existing user questions of one or more candidate product objects that are similar to the first product object.
